(19) United States
(12) Patent Application Publication
(10) Pub. No.: US 2026/0197690 A1
(43) Pub. Date: Jul. 9, 2026

(54) METHODS AND SYSTEMS FOR PROCESSING PERIODIC USER EQUIPMENT MEASUREMENTS

(71) Applicant: T-Mobile USA, Inc., Bellevue, WA (US)

(72) Inventor: Roopesh Kumar Polaganga, Bothell, WA (US)

(21) Appl. No.: 19/015,370

(22) Filed: Jan. 9, 2025

(51) Int. Cl. H04W 24/10; H04W 48/16; H04W 64/00

(52) U.S. Cl. CPC H04W 24/10; H04W 48/16; H04W 64/003

(57) ABSTRACT

Methods and systems for processing periodic user equipment (UE) measurements in a wireless communication network utilize an X2 interface to distribute the processing tasks to the access points configured with the capacity. In an implementation, an access point that has limited capacity may send the measurement data to a second access point equipped with a Fourth Generation (Gen-4) baseband processor. The second access point may process the measurement data and send a result back to the access point. Based on the result, the access point may determine whether a handover is needed. The access point may handover the UE from a current serving cell to a neighboring cell. Alternatively, the access point may handover the UE from a current operating frequency to a different frequency within the same cell. The access point may also send the result to a performance optimization server to take additional actions on the network optimization.

In advanced telecommunication networks, the ability to collect and analyze periodic user equipment (UE) measurements such as reference signal received power (RSRP), reference signal received quality (RSRQ), and signal-to-interference-plus-noise ratio (SINR) is critical for optimizing network performance. These measurements are particularly valuable in both Fifth Generation (5G) new radio (NR) standalone (SA) mode and non-standalone (NSA) mode as they provide real-time insights into the performance of NR primary cell (P-Cell)/secondary cell (S-Cell) and other neighboring cells.

How ever, the periodic collection and processing of the UE measurements are highly resource incentive. Currently, only gNBs equipped with the Fourth Generation (Gen-4) baseband processors have the processing power to perform periodic UE measurements. Such limitation leaves the access points with older baseband processors (e.g., non-Gen-4 gNBs) unable to utilize these advanced measurement capabilities, potentially leading to suboptimal network performance in areas covered by those non-Gen-4 gNBs.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example scenario, in which methods for processing periodic UE measurements are implemented according to the present disclosure.

FIG. 2 illustrates another example scenario, in which methods for processing periodic UE measurements are implemented according to the present disclosure.

FIG. 3 illustrates yet another example scenario, in which methods for processing periodic UE measurements are implemented according to the present disclosure.

FIG. 4 illustrates an example process for processing periodic UE measurements are implemented according to the present disclosure.

FIG. 5 illustrates an example computing device, in which methods for processing periodic UE measurements are implemented according to the present disclosure.

### DETAILED DESCRIPTION

Techniques for processing periodic UE measurements are disclosed herein.

In some implementations, a method for processing periodic UE measurements may be implemented by a computing device associated with an access point (e.g., base stations, eNodeBs, gNodeBs, etc.) in a wireless communication network. The access point may receive, from a user equipment (UE), measurement data associated with received signals from one or more cells discoverable to the UE. The access point may determine that it has no capacity or limited capacity to process the measurement data and forward the measurement data to a second access point that has the capacity. The second access point may process the measurement data and send a result back to the access point. The access point may perform, based at least in part on the result, an action on the UE to optimize network performance.

In implementations, the second access point may be configured with a Fourth Generation (Gen-4) baseband processor.

In implementations, the measurement data may be generated periodically according to a configuration set by the access point.

In implementations, the received signals from the one or more cells visible to the UE may be transmitted using one of a low-band spectrum utilizing the sub-1 GHz, a mid-band spectrum operating on a frequency range between 2 GHz and 6 GHz, and a high-band spectrum operating on frequencies above 24 GHz.

In implementations, the measurement data includes at least one of a reference signal received power (RSRP), a reference signal received quality (RSRQ), or a signal-to-interference-plus-noise ratio (SINR).

In implementations, the access point and the second access point may operate in one of a standalone mode or a non-standalone mode.

In implementations, the wireless communication network includes a plurality of second access points configured with the capacity to process the measurement data. The access point may further determine, based at least in part on a geographic location of the plurality of second access points, the second access point, and send a request to the second access point. Once the second access point agrees to process the measurement data, the access point may forward the measurement data to the second access point. The access point may further receive, from the second access point, a result of processing the measurement data. In some examples, the access point may forward the raw measurement data to the second access point. The result of processing the measurement data may indicate RSRP levels from all visible cells at a current operating frequency, RSRQ levels from all visible cells at the operating frequency, SINR levels from all visible cells at the operating frequency.

In implementations, the action on the UE to optimize the network performance may include one or more of handover the UE from a current cell to another cell, handover the UE from a current frequency spectrum to another frequency spectrum in a same cell, or handover the UE from the access point to another access point.

In implementations, the access point may forward the measurement data to the second access point through an X2 interface.

In implementations, the access point may further send the result of processing the measurement data to a performance management server. The performance management server may perform an additional action to optimize the performance of the wireless communication network such as adjusting the base station power settings, adjusting the base station antenna settings, etc.

In implementations, upon receiving periodic measurement associated with received signals from one or more cells visible to the UE, the access point may determine whether the processor has the processing capacity. When it is determined that the processor has the processing capacity (e.g., the processor equipped with a Gen-4 or higher generation processor), the access point may process the periodic measurement data to generate a result. The access point may further perform, based at least in part on the result, an action on the UE to optimize performance of the wireless communication network.

The present disclosure utilizes an X2 interface to distribute the processing of periodic UE measurement data to the access points with high capacity (e.g., equipped with Gen-4 or higher generation baseband processor) when the current access point has no capacity or limited capacity. By offloading the processing tasks associated with the periodic UE measurement data to Gen-4 access point, non-Gen-4 access points can provide the same level of measurement based network optimization as their more advanced counterparts. Thus, the present disclosure allows all UEs, regardless of their connected access points, to benefit from the enhanced network performance driven by the detailed periodic measurement reports.

The techniques discussed herein may be implemented in a computer network using one or more of protocols including but are not limited to Ethernet, Third Generation (3G), Fourth Generation (4G), 4G Long-Term Evolution (LTE), Fifth Generation (5G), Sixth Generation (6G), other radio access technologies, or any combination thereof wherever carrier aggregation concepts and principles apply. Example implementations are provided below with reference to the following figures.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

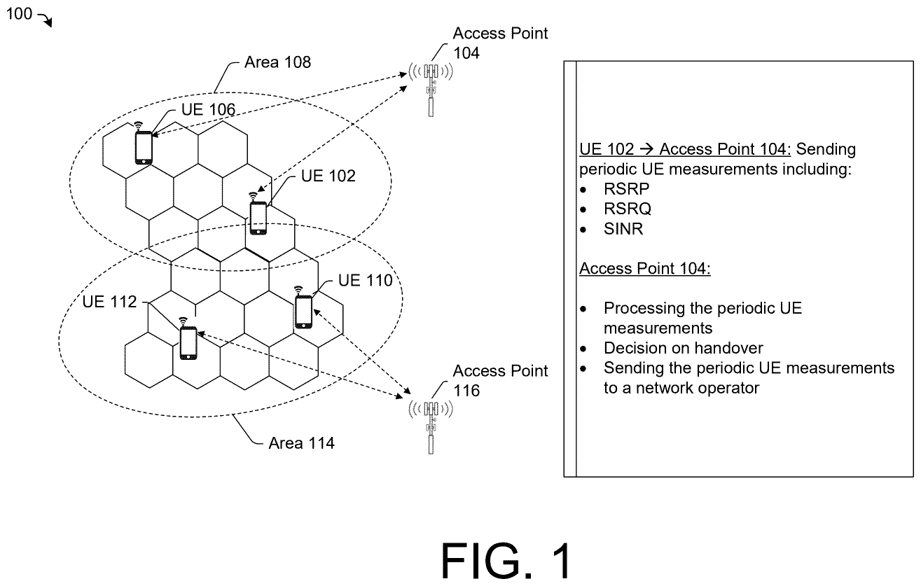

FIG. 1 illustrates an example scenario, in which methods for processing periodic UE measurements are implemented according to the present disclosure.

Example scenario 100, as illustrated in FIG. 1, may be associated with a telecommunication network of a wireless service provider. One or more user equipment may attach to a Public Land Mobile Network (PLMN) of the wireless service provider through various access points. As shown in FIG. 1, UE 102 and UE 106 are located in an area 108 covered by access point 104 and may register to a core network of the wireless service provider through the access point 104. UE 110 and UE 112 are located in an area 114 covered by access point 116 and may register to the core network of the wireless service provider through the access point 116.

The UE (e.g., UE 102, UE 106, UE 110, or UE 112) may be any device that can wirelessly connect to a telecommunication network. The UE may support various radio access technologies such as Bluetooth, Wi-Fi, Global System for Mobile Communications (GSM), Code Division Multiple Access (CDMA), Wideband Code Division Multiple Access (WCDMA), Universal Mobile Telecommunications System (UMTS), 4G/LTE or 5G NR. In some examples, the UE may be a mobile phone, such as a smart phone or other cellular phone. In other examples, the UE may be a personal digital assistant (PDA), a media player, a tablet computer, a gaming device, or any other type of computing or communication device. In yet other examples, the UE may include the computing devices implemented on the vehicle including but are not limited to, an autonomous vehicle, a self-driving vehicle, or a traditional vehicle capable of connecting to internet. In yet other examples, the UE may be a wearable device and/or wearable materials, such as a smart watch, smart glasses, clothes made of smart fabric, etc. In further examples, the UE may be a virtual reality or augmented reality goggles or glasses.

In implementations, the access point (e.g., access point 104 or access point 116) may be compatible with one or more radio access technologies, protocols, and/or standards, such as 5G NR technology, LTE/LTE Advanced technology, other 4G technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. In some examples, the access point may be a gNB associated with a 5G radio access network (RAN) or an eNB associated with a 4G/LTE RAN. Although not shown, the access point may also be associated with a Second Generation (2G) base station, a Third Generation (3G) NodeBs associated with GSM and CDMA access network, digital subscriber line (DSL) and variations of DSL technology that provide access to desktops, workstations, and/or mainframes, Wi-Fi connections to the user equipment, etc.

In some examples, the UE may send a measurement report to the access point when a specific event happens such as a serving cell signal being dropped below a threshold, triggering a potential handover decision. In some other examples, once the UE attaches to the network (e.g., the PLMN of the wireless service provider), the access point may set a configuration for the UE, where the configuration defines a time interval that the UE should periodically send a measurement report associated with its serving cell and all discoverable neighboring cells. In yet some other examples, a network operator (e.g., performance management server, network orchestrator, etc.) may set specific parameters defining when and how often the UE should send a measurement report based on factors such as network congestion and desired handover behavior. In some examples, the neighboring cells visible to the UE may include not only the cells of the UE's own service provider but also the cells of other wireless service providers.

As illustrated, the UE 102 may send periodic UE measurements to the access point 104. As discussed herein, the UE 102 may receive signals transmitted by nearby base stations. The base stations that the UE 102 can receive signals become “visible” or “discoverable” to the UE 102. The periodic UE measurements may include multiple parameters indicative of the signal quality of the serving cell and neighbor cells visible to the UE 102 such as RSRP, RSRQ, SINR, etc. In some examples, the access point 104 may operate across a wide range of frequency bands, including a low-band spectrum utilizing the sub-1 GHz, a mid-band spectrum operating on a frequency range between 2 GHz and 6 GHz, and a high-band spectrum operating on frequencies above 24 GHz. The access point 104 may configure multiple cells for each of the low-band spectrum, the mid-band spectrum, and the high-band spectrum. In implementations, the access point 104 may set the time interval that the UE 102 should report the periodic UE measurement by as 5 seconds, 10 seconds, 15 seconds, etc.

Upon receiving the periodic UE measurement, the access point 104 may process the UE measurement and determine, based on a processing result, whether a handover of the UE 102 is needed to optimize the network performance. In implementations, the access point 104 may also send the UE measurement report and the processing result to the network operator (not shown) to determine additional actions to optimize the network performance.

In some examples, the UE measurement received at time t₁ may indicate that the UE 102 receives poor signal strength from a base station of the current serving cell (e.g., the RSRP from the base station of the current serving cell is measured as −110 dBm) but receives good signal strength from a base station of a neighboring cell (e.g., the RSRP from the base station of the neighboring cell is measured as −85 dBm). If the measured RSRP for the current serving cell meets or drops below a pre-configured threshold (e.g., RSRP<=−120 dBm), the access point 104 may handover the UE 102 from the current serving cell to the neighboring cell. In some examples, the UE 102 may receive good signal strength from multiple base stations of the neighboring cells, the access point 104 may handover the UE 102 from the current serving cell to the neighboring cell that has the strongest RSRP measurement. In yet some examples, the UE measurement may indicate that the UE 102 receives poor signal strength from the current serving cell (e.g., the RSRP of the current serving cell is measured as −110 dBm) and slightly better signal strength from the neighboring cell (e.g., the RSRP of the neighboring cell is measured as −95 dBm). The access point 104 may determine to monitor the RSRPs in the subsequent UE measurements. If the RSRP of the current serving cell is not improved (e.g., the RSRP of the current serving cell is still <=−110 dBm) and the RSRP of a neighboring cell becomes much stronger than the RSRP of the current serving cell (e.g., the RSRP of the neighboring cell is at least 20 dBm stronger than the RSRP of the current serving cell), the access point 104 may handover the UE 102 from the current serving cell to the neighboring cell.

In some other examples, the UE measurement received at time t₂ may indicated that the RSRQ of the current serving cell has decreased from time t₁ (e.g., the RSRQ has decreased from −10 dB to −18 dB). If the UE 102 currently operates at the millimeter wave band (e.g., high-band spectrum), the RSRQ deterioration may be due to the interference from obstacles (e.g., buildings, trees, etc.) or atmospheric conditions like rain, fog, or sources of electromagnetic radiation. The access point 104 may further determine whether the RSRQ of the current serving cell has dropped to be equal to or lower than a first pre-configured threshold. If the RSRQ of the current serving cell has dropped to be equal to or below the first pre-configured threshold, the access point 104 may switch the UE 102 from operating at the millimeter wave band to a mid-band frequency within the current serving cell. In some examples, if the RSRQ of the current serving cell is significantly deteriorated due to obstacles like buildings (e.g., the RSRQ of the current serving cell has dropped to be equal to or lower than a second pre-configured threshold lower than the first pre-configured threshold), the access point 104 may switch the UE 102 from operating at the millimeter wave band to a low-band frequency within the current serving cell to allow the signals to have better penetration to the buildings.

In yet other examples, the UE measurement received at time t₂ may also indicate that the RSRQ of the current serving cell is lower than those of one or more neighboring cells. The access point 104 may determine whether to switch the UE 102 to a neighboring cell and/or switch the UE 102 to operate at a different frequency range based on various factors. The various factors may include but are not limited to the current operating frequency of the UE (e.g., high-band spectrum, mid-band spectrum, or low-band spectrum, etc.), whether the RSRQ of the current serving cell is equal to or less than a threshold, whether the RSRQ of a neighboring cell is at least a threshold higher than the RSRQ of the current serving cell, whether there are multiple neighboring cells having better RSRQ measurements, etc.

In yet other examples, the UE measurement received at time t₃ may indicated that the SINR of the current serving cell is lower than a threshold and/or lower than the SINR of a neighboring cell. For example, the SINR of the current serving cell may have dropped to be lower than 0 dB while a neighboring cell has an SINR as 5 dB. The access point 104 may determine to handover the UE 102 from the current serving cell to the neighboring cell based at least in part on whether the SINR of the current serving cell is equal to or less than the threshold, whether the gap between the SNIRs of the neighboring cell and the current serving cell is equal to or greater than a threshold, whether there are multiple neighboring cells having less interference, etc.

In some examples, the access point 104 may alternatively or additionally send the UE measurement to a network operator (e.g., performance optimization server). The network operator may modify the power settings of base stations of the cells to improve the network performance in terms of RSRQ, RSRQ, SINR, etc. For example, the network operator may adjust the power settings of the base stations to increase the power of the base station of the current serving cell and/or to reduce the power of the base stations of one or more neighboring cells. In another example, the network operator may adjust the antenna settings (e.g., angle of a directional antenna) in the base station of the current serving cell to help reduce the interference from the neighboring cells.

It should be understood that the example scenario 100 is for the purpose of illustration. The present disclosure is not intended to be limiting. The access point 104 may similarly process the periodic UE measurements sent from UE 106 and all other UE attached to the access point 104. Additionally, the access point 116 may process the periodic UE measurements sent from UE 110, UE 112, and all other UE attached to the access point 116. Further, as the UE measurement indicates various conditions of the communication channels between the UE and base stations, the access point may determine different actions based on those conditions to improve the network performance. These actions may include at least one of handover of the UE from a current serving cell to a neighboring cell yet maintaining the current operating frequency for the UE, handover of the UE from the current operating frequency to a different frequency within the current serving cell, handover of the UE from a current serving cell to a neighboring cell and switching from an operating frequency to a different frequency, reporting the UE measurement to an upstream server that handles network performance optimization, or the combination thereof.

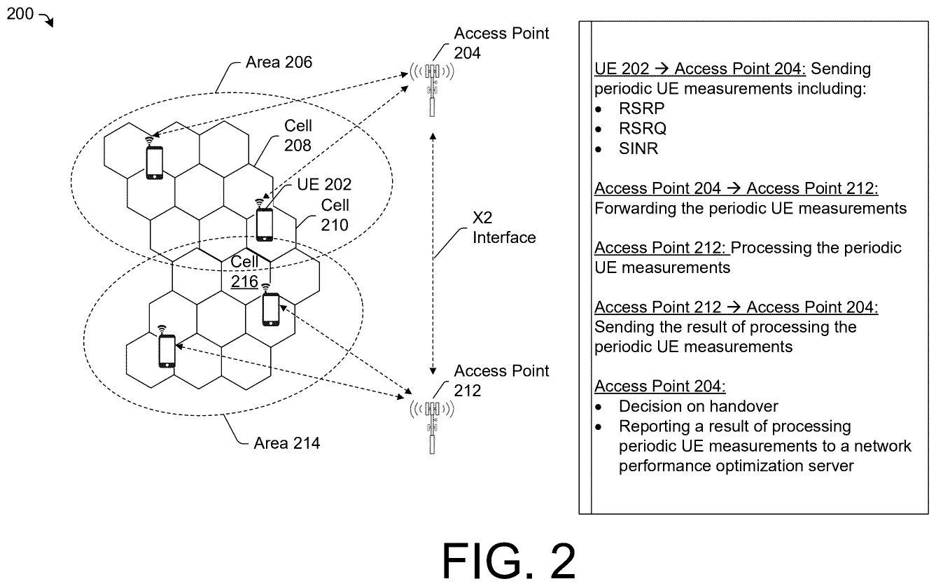

FIG. 2 illustrates another example scenario, in which methods for processing periodic UE measurements are implemented according to the present disclosure. Example scenario 200, as shown in FIG. 2, may be implemented in circumstances where an access point has limited capacity to process the periodic UE measurement reports.

As discussed herein, the UE may periodically measure the received signals from the current serving cell and all neighboring cells discoverable to the UE. In the 5G network, a gNB may support multiple frequency spectrums such as a low-band spectrum, a mid-band spectrum, and a high-band spectrum. The gNB may configure a number of cells in each frequency spectrum, for example, three cells in each frequency spectrum. In implementations, if a gNB supports three frequency spectrums and three cells in each of the three frequency spectrum, the gNB supports nine cells. In addition, when the UE attaches to the network, the gNB may assign a request to the UE, which defines how often the UE should report the measurements (e.g., every 5 seconds, every 10 seconds, every 15 seconds, etc.). As each of the cells may serve hundreds of UE, the periodic collection and processing of the UE measurements are highly resource intensive. In implementations, a gNB equipped with a baseband processor older than the fourth generation baseband (Gen-4 baseband) processor may have no capacity or limited capacity to process the periodic UE measurements. Because these measurements are critical for optimizing the network performance, the gNBs with no capacity or limited capacity (e.g., the non-Gen-4 gNBs) may offload the processing tasks associated with the UE measurements to a gNB equipped with Gen-4 baseband processors (e.g., Gen-4 gNB).

The example scenario 200 shows an access point 204 that is a non-Gen-4 gNB and has limited capacity to process the periodic UE measurements sent from all UEs in area 206, and an access point 212 that is a Gen-4 gNB equipped with capacity to process the periodic UE measurements sent from all UEs in area 214. Some UE in the area 206 receives fair to excellent signal strength and quality while other UE experiences poor signal quality and/or high interference. To improve user experience, timely processing the periodic UE measurements and take actions such as mobility triggering, interference management, and load balancing is necessary. For example, UE 202 attached to a base station of cell 208 has roamed to the border area and experiences signal deterioration at the border area. The UE 202 may send the periodic UE measurement to the access point 204. The periodic UE measurement may include the measurements of RSRP, RSRQ, and SINR for each cell visible to the UE 202 at a current operating frequency. The UE 202 may additionally send a signaling message to the access point 204 to indicate a type of message it is sending (e.g., UE measurement report). As the access point 204 is a non-Gen-4 gNB and has limited capacity to process the UE measurement report, upon determining that the incoming message includes the UE measurement report, the access point 204 may identify a nearby Gen-4 gNB (e.g., the access point 212) and forward the UE measurement report to the access point 212 to process. In implementations, the access point 204 (i.e., the non-Gen-4 gNB) may forward the raw data of the UE measurements to the access point 212 (i.e., the Gen-4 gNB). The access point 204 may utilize the X2 interface to communicate with the access point 212 and forward the UE measurement report.

In implementations, when more than one Gen-4 gNB is available, the non-Gen-4 gNB may choose one Gen-4 gNB to send the request to assist with processing the UE measurement data. If the Gen-4 gNB is heavily loaded and rejects the request, the non-Gen-4 gNB may send the request to another available Gen-4 gNB for assistance. In some examples, the non-Gen-4 gNB may choose the Gen-4 gNB based on the geographic locations of these Gen-4 gNBs.

Upon receiving the UE measurement reports, the access point 212 may process the measurement data and send a result back to the access point 204. The result may indicate the received signal strength associated with all cells visible to the UE 202 such as, poor RSRP for serving cell 208, good RSRP for neighboring cell 210, fair RSRP for neighboring cell 216, etc. In some examples, the result may also indicate the received signal quality associated with all cells visible to the UE 202 such as, poor RSRQ for cell 208, good RSRQ for cell 210, fair RSRQ for cell 216, etc. In yet some other examples, the result may further indicate the signal to interference plus noise ratio (SINR) associated with all cells visible to the UE 202 such as, poor SINR for cell 208, good SINR for cell 210, fair SINR for cell 216, etc.

In some examples, the result of processing the periodic UE measurements may indicate whether the RSRP of the serving cell has dropped to be equal to or lower than a pre-set RSRP threshold, whether the RSRQ of the serving cell has dropped to be equal to or lower than a pre-set RSRQ threshold, whether the SINR of the serving cell has dropped to be equal to or lower than a pre-set SINR, or the combination thereof. In some examples, the pre-set RSRP threshold, the pre-set RSRQ threshold, or the pre-set SINR threshold may be configured differently for different frequency spectrum. For example, the pre-set RSRP threshold for high-band spectrum may be configured to be greater than that of mid-band spectrum. In another example, the pre-set SINR threshold for mid-band spectrum may be configured to be greater than that of low-band spectrum.

In yet some other examples, the result may include suggested actions to optimize the network performance such as handover the UE 202 from the current serving cell to a neighboring cell, handover the UE 202 from the current frequency spectrum to a different frequency spectrum, reporting the UE measurements to a network performance optimization server, sending the result along with the UE measurement to the network performance optimization server, etc. In implementations, the access point 212 (i.e., the Gen-4 gNB) may return the result of processing the periodic UE measurement to the access point 204 (i.e., the non-Gen-4 gNB) in milliseconds.

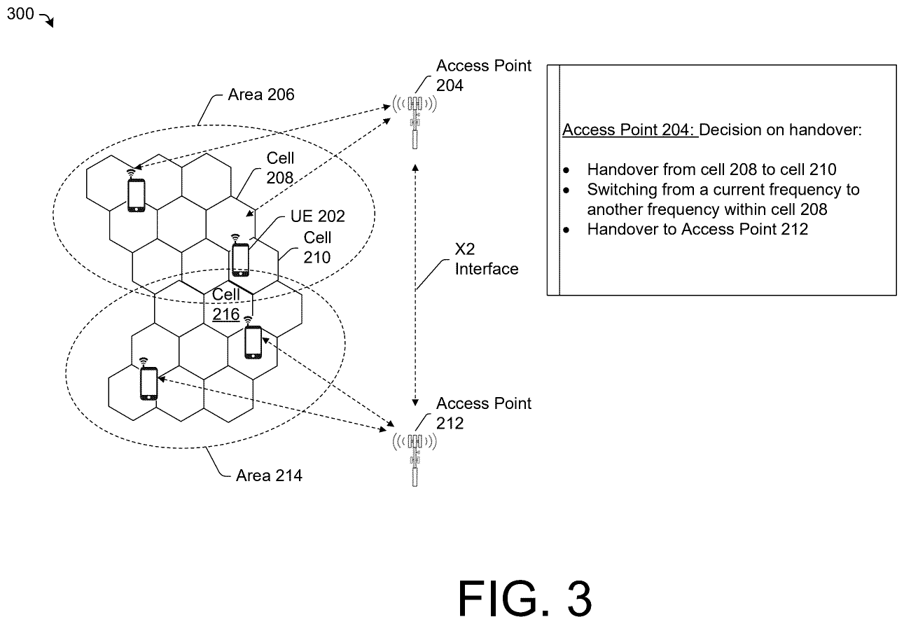

Once receiving the result of processing the periodic UE measurement from the access point 212 (i.e., the Gen-4 gNB), the access point 204 (i.e., the non-Gen-4 gNB) may determine an appropriate action based on the result to optimize the network performance. Alternatively or additionally, the access point 204 (i.e., the non-Gen-4 gNB) may refer to the actions suggested by the access point 212 (i.e., the Gen-4 gNB) and make the decision to optimize the network performance. As illustrated in FIG. 3, the access point 204 may handover the UE 202 from cell 208 to cell 210, switch the UE 202 from a current frequency to another frequency within cell 208, or handover the UE 202 to the access point 212, etc. Additionally, the access point 204 (i.e., the non-Gen-4 gNB) may send the result (e.g., the processed UE measurement report) to an upstream server that handles network performance optimization. The upstream server may determine additional actions to optimize the network performance such as modifying the power settings and/or antenna settings of the base stations to reduce interference from neighboring cells. As discussed herein, with the assistant of the Gen-4 gNB, the non-Gen-4 gNB can timely capture the real-time signal conditions and act quickly to optimize the network performance. Further, even though the non-Gen-4 gNB receives assistance from the Gen-4 gNB, the non-Gen-4 gNB still forwards the processed UE measurement data to the upstream server that handles network performance optimization as if the UE measurements are processed locally. This ensures seamless integration with the rest of the wireless communication network, even though the distributed processing is occurring behind the scenes.

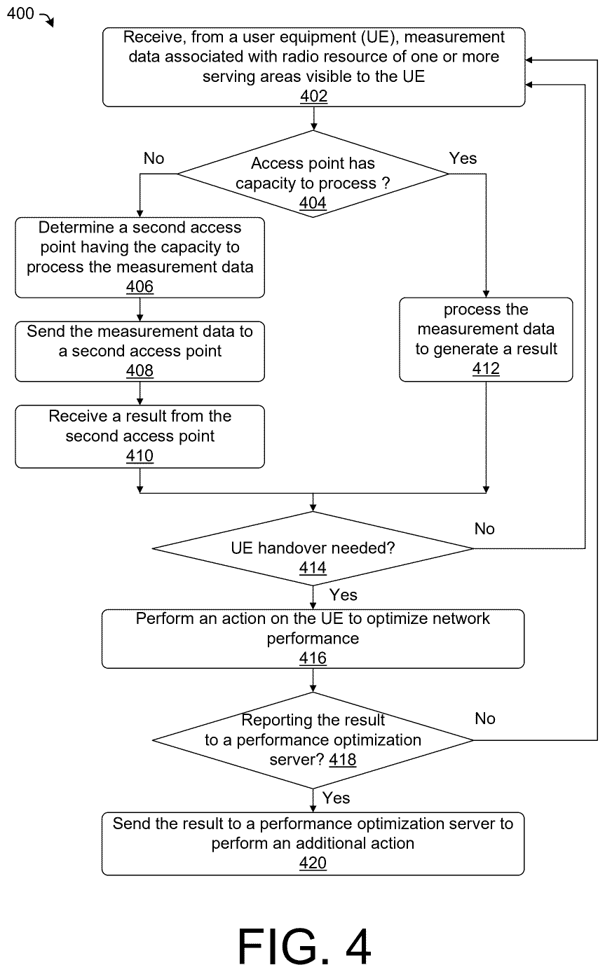

FIG. 4 illustrates an example process for processing periodic UE measurements are implemented according to the present disclosure. The example process 400 may be performed by an access point in a wireless communication network (e.g., the access point 104 and access point 116 of FIG. 1, the access point 204 and access point 212 of FIG. 2, etc.). The access point may be equipped with high capacity baseband processors to process the UE measurement data periodically sent by the UE attached to the base station (e.g., gNBs with Gen-4 or higher generation baseband processors). In some implementations, the access point may be equipped with older generation baseband processors and may have limited capacity to process the periodic UE measurement data (e.g., 2G/3G base stations, eNBs, gNBs with baseband processor older than Gen- 4, etc.).

At operation 402, an access point may receive, from a user equipment (UE), measurement data associated with radio resource of one or more serving areas visible to the UE. The UE may send the measurement data periodically to the access point, e.g., base station, eNB, gNB, etc. The measurement data may include but is not limited to reference signal received power (RSRP), reference signal received quality (RSRQ), signal to interference plus noise ratio (SINR), etc. The UE may measure the RSRP, RSRQ, and SINR in the serving cell and all visible neighboring cells. The UE measurement data may also indicate a frequency band, in which, the UE operates at the time the measurement is performed. As discussed herein, the UE may send a signaling message to indicate the UE measurement data is coming through. The access point may identify the UE measurement data based at least in part on the signaling message.

At operation 404, the access point may determine whether it has capacity to process. As discussed herein, the access points equipped with Gen-4 baseband processors normally have capacity to process the periodic UE measurement data, while the access points equipped with older generation baseband processors may have no capacity or limited capacity to process the periodic UE measurement data.

If it is determined that the access point has the capacity to process, at operation 412, the access point may process the measurement data to generate a result.

If it is determined that the access point has no capacity or limited capacity to process, the access point may determine a second access point having the capacity to process the measurement data at operation 406. In some examples, the access point may maintain a list of access points (e.g., base stations, eNBs, gNBs, etc.) connected to the core network. Based on the configuration of the access points, the access point may identify one or more second access points having the capacity to process (e.g., equipped with Gen-3 baseband processors).

At operation 408, the access point may send the measurement data to the second access point. As discussed herein, once the access point determines that the incoming data is the UE measurement data, the access point may forward the raw measurement data directly to the second access point without looking into the measurement data. In some examples, the raw measurement data may include the measured values for parameters indicative of the received signal quality at the UE. For example, the raw measurement data may include measured RSRP in dBm for each visible cell at a certain frequency band, measured RSRQ in dB for each visible cell at a certain frequency band, measured SINR in dB for each visible cell at a certain frequency band, etc.

At operation 410, the access point may receive a result from the second access point. In some examples, the result of processing the UE measurement data may indicate the received signal quality in terms of RSRP, RSRQ, and/or SINR for each visible cell at the certain frequency band. For example, the result may indicate the UE operating in high-band spectrum, receives fair RSRP from its serving cell, good RSRP from a first neighboring cell, poor RSRP from a second neighboring cell, etc. In another example, the result may indicate the UE operating in high-band spectrum, receives fair SINR from its serving cell, good SINR from the first neighboring cell, poor SINR from the second neighboring cell, etc. In yet some other examples, the result may include a list of cells sorted by the measured values of RSRP, RSRQ, and/or SINR in each frequency band. In yet some other examples, the result may indicate whether the measured signal quality (e.g., RSRP, RSRQ, and/or SINR) for the serving cell has dropped to be equal to or below a threshold.

At operation 414, the access point may determine whether UE handover is needed. In implementations, various conditions may trigger a UE mobility handover. For example, poor RSRP, poor RSRQ, poor SINR, and the combination thereof for the serving cell (e.g., dropped below a threshold) may trigger a decision to handover the UE to a neighbor cell where the UE received stronger signal, better quality, and/or less interference.

If it is determined that the UE handover is needed, at operation 416, the access point may perform an action on the UE to optimize network performance. In some examples, the access point may switch the UE from the current serving cell to a neighboring cell having a highest RSRP measurement. In other examples, the access point may switch the UE from the current serving cell to a neighboring cell having a highest RSRQ measurement. In yet other examples, the access point may switch the UE from the current serving cell to a neighboring cell having a highest SINR measurement. In yet other examples, the access point may switch the UE from a current high-band spectrum to a mid-band spectrum. In yet other examples, the access point may determine the action based on a combination of multiple measurements (e.g., RSRP, RSRQ, SINR, etc.). In some other examples, the access point may determine the action further based on the geographic locations of the base stations in neighboring cells.

If it is determined that the UE handover is not needed, the computing device associated with the access point may continue to monitor the incoming signaling messages from the UE, e.g., returning to operation 402.

At operation 418, the computing device may further determine whether to report the result to a performance optimization server. In some examples, the UE measurement data may indicate very poor RSRQ, very poor RSRQ, and/or very poor SINR in the current serving cell. The computing device may send the result to the performance optimization server to perform an additional action at operation 420. In implementations, the additional action may include adjusting the power configuration for related base stations to reduce the neighboring cell interference. For example, the performance optimization server may increase the power of the base station in the serving cell and/or decrease the power of the base stations in the neighbor cells. In another example, the performance optimization server may adjust the antenna settings of the base station in the serving cell (e.g., adjusting an angle of the directional antenna) to reduce the interference from neighboring cells. In the 5G network, the performance optimization server (e.g., network orchestrator) may also take the additional actions based on the network slice and/or quality of service (QoS) assigned to the UE.

If it is determined that there is no need to report the result to a performance optimization server, the computing device may continue to monitor the incoming signaling messages from the UE, e.g., returning to operation 402.

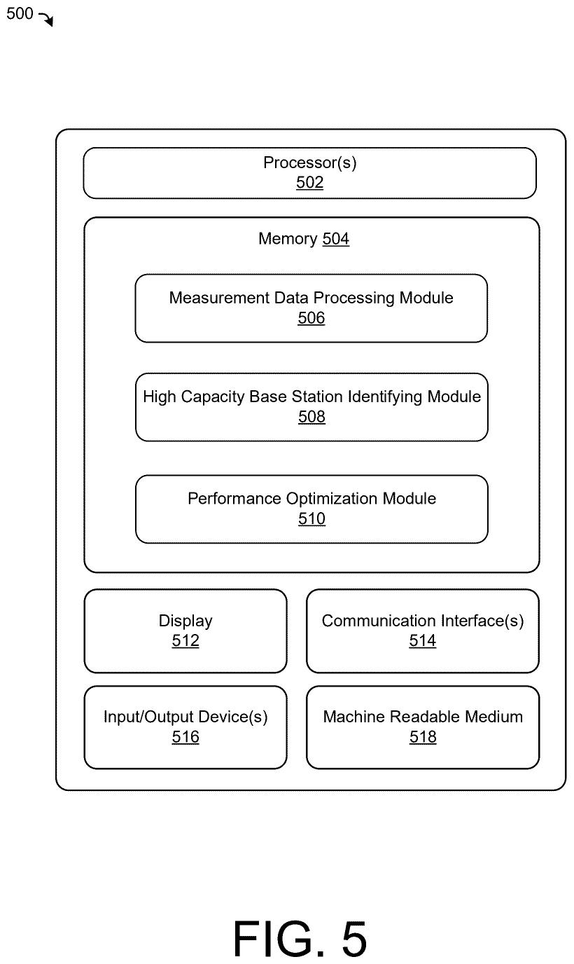

FIG. 5 illustrates an example computing device, in which methods for processing periodic UE measurements are implemented according to the present disclosure. The example computing device 500 may correspond to a computing device associated with an access point in a wireless communication network (e.g., the access point 104 and access point 116 of FIG. 1, the access point 204 and access point 212 of FIG. 2, etc.).

As illustrated in FIG. 5, a computing device 500 may comprise processor(s) 502, a memory 504 storing a measurement data processing module 506, a high capacity base station identifying module 508, and a performance optimization module 510, a display 512, communication interface(s) 514, input/output device(s) 516, and/or a machine readable medium 518.

In various examples, the processor(s) 502 can be a central processing unit (CPU), a graphics processing unit (GPU), or both CPU and GPU, or any other type of processing unit. Each of the one or more processor(s) 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 502 may also be responsible for executing all computer applications stored in memory 504, which can be associated with common types of volatile (RAM) and/or nonvolatile (ROM) memory.

In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 500. Any such non-transitory computer-readable media may be part of the computing device 500.

The measurement data processing module 506 may be configured to process the measurement data sent from the UE attached to the access point. The measurement data may be triggered by certain events or periodically taken according to the request of the access point. When the access point is configured with capacity to process the periodic UE measurement data, the measurement data processing module 506 may read the measured parameters indicative of the signal quality of all cells discoverable to the UE (e.g., RSRP values, RSRQ values, SINR values, etc.). The measurement data processing module 506 may determine, based on the measured parameters, whether the network performance needs to be optimized.

The high capacity access point identifying module 508 may be configured to identity one or more access points with high capacity to process the periodic UE measurement data. When the access point is equipped with old generation baseband processor (e.g., older than Gen-4 baseband processor), the high capacity access point identifying module 508 may obtain a list of access points connected to the network and identity those access points with Gne-4 or higher generation baseband processors. The high capacity access point identifying module 508 may further request assistant from the high capacity access point to process the UE measurement data.

The performance optimization module 510 may be configured to take actions to optimize the network performance. The performance optimization module 510 may determine the actions based on the processing result of the UE measurement data. As discussed herein, the processing result may be generated by the measurement data processing module 506 or the high capacity access point identified by the high capacity access point identifying module 508. In implementations, the actions to optimize the network performance may include handover the UE from the current serving cell to a neighboring cell, handover the UE from a high-band spectrum to a mid-band spectrum, handover the UE from the current access point to another access point, etc. In some examples, the actions may further include reporting the processing result of the UE measurement data to a performance optimization server (e.g., network manager, network orchestrator, etc.).

The communication interface(s) 514 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 514 can be compatible with multiple radio access technologies, such as 5G radio access technologies and 4G/LTE radio access technologies. Accordingly, the communication interface(s) 514 can allow the computing device 500 to connect to the 5G system described herein.

Display 512 can be a liquid crystal display or any other type of display commonly used in the computing device 500. For example, display 512 may be a touch-sensitive display screen and can then also act as an input device or keypad, such as for providing a soft-key keyboard, navigation buttons, or any other type of input. Input/output device(s) 516 can include any sort of output devices known in the art, such as display 512, speakers, a vibrating mechanism, and/or a tactile feedback mechanism. Input/output device(s) 516 can also include ports for one or more peripheral devices, such as headphones, peripheral speakers, and/or a peripheral display. Input/output device(s) 516 can include any sort of input devices known in the art. For example, input/output device(s) 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, which embodies any one or more of the methodologies or functions described herein. The instructions can also reside, completely or at least partially, within the memory 504, processor(s) 502, and/or communication interface(s) 514 during execution thereof by the computing device 500. The memory 504 and the processor(s) 502 also can constitute machine readable medium 518.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computer-implemented method implemented by an access point of a wireless communication network, comprising:
receiving, from a user equipment (UE), measurement data associated with received signals from one or more cells visible to the UE;
forwarding the measurement data to a second access point, causing the second access point to process the measurement data;
receiving, from the second access point, a result of processing the measurement data; and
performing, based at least in part on the result, an action on the UE to optimize performance of the wireless communication network.

2. The computer-implemented method of claim 1, wherein the second access point is configured with a Fourth Generation (Gen-4) baseband processor.

3. The computer-implemented method of claim 1, wherein the measurement data is generated periodically according to a configuration set by the access point.

4. The computer-implemented method of claim 1, wherein the received signals from the one or more cells are transmitted using a spectrum of a high-band spectrum, a mid-band spectrum, and a low-band spectrum, and the measurement data indicates the spectrum.

5. The computer-implemented method of claim 1, wherein the measurement data includes at least one of:
a reference signal received power (RSRP) for each of the one or more cells,
a reference signal received quality (RSRQ) for each of the one or more cells, or
a signal-to-interference-plus-noise ratio (SINR) for each of the one or more cells.

6. The computer-implemented method of claim 1, wherein the access point and the second access point operate in a standalone mode or a non-standalone mode.

7. The computer-implemented method of claim 1, wherein the wireless communication network includes a plurality of second access points, and the computer-implemented method further comprises:
determining, based at least in part on a geographic location of the plurality of second access points, the second access point;
sending, to the second access point, a request to forward the measurement data; and
receiving, from the second access point, a response indicative of an approval to forward the measurement data.

8. The computer-implemented method of claim 1, wherein the action on the UE to optimize the performance of the wireless communication network includes at least one of:
handover the UE from a current cell to another cell,
handover the UE from a current spectrum to another spectrum in a same cell, or
handover the UE from the access point to another access point.

9. The computer-implemented method of claim 1, wherein the access point forwards the measurement data to the second access point through an X2 interface.

10. The computer-implemented method of claim 1, further comprising:
sending the result of processing the measurement data to a performance management server, causing the performance management server to perform an additional action to optimize the performance of the wireless communication network.

11. A computing device associated with an access point in a wireless communication network, comprising:
a processor; and
a non-transitory computer-readable memory storing computer-executable instructions that, when executed by the processor, cause the processor to perform actions including:
receiving, from a user equipment (UE), measurement data associated with received signals from one or more cells visible to the UE;
forwarding the measurement data to a second access point, causing the second access point to process the measurement data;
receiving, from the second access point, a result of processing the measurement data; and
performing, based at least in part on the result, an action on the UE to optimize performance of the wireless communication network.

12. The computing device of claim 11, wherein the second access point is configured with a Fourth Generation (Gen-4) baseband processor.

13. The computing device of claim 11, wherein the measurement data is generated periodically according to a configuration set by the access point.

14. The computing device of claim 11, wherein the received signals from the one or more cells are transmitted using a spectrum of a high-band spectrum, a mid-band spectrum, and a low-band spectrum, and the measurement data indicates the spectrum.

15. The computing device of claim 11, wherein the measurement data includes at least one of:
a reference signal received power (RSRP) for each of the one or more cells,
a reference signal received quality (RSRQ) for each of the one or more cells, or
a signal-to-interference-plus-noise ratio (SINR) for each of the one or more cells.

16. The computing device of claim 11, wherein the access point and the second access point operate in a standalone mode or a non-standalone mode.

17. The computing device of claim 11, wherein the wireless communication network includes a plurality of second access points, and the computer-executable instructions, when executed by the processor, cause the processor to perform the actions further including:
determining, based at least in part on a geographic location of the plurality of second access points, the second access point;
sending, to the second access point, a request to forward the measurement data; and
receiving, from the second access point, a response indicative of an approval to forward the measurement data.

18. The computing device of claim 11, wherein the action on the UE to optimize the performance of the wireless communication network includes at least one of:
handover the UE from a current cell to another cell,
handover the UE from a current spectrum to another spectrum in a same cell, or
handover the UE from the access point to another access point.

19. The computing device of claim 11, wherein the access point forwards the measurement data to the second access point through an X2 interface.

20. A computing device associated with an access point in a wireless communication network, comprising:
a processor; and
a non-transitory computer-readable memory storing computer-executable instructions that, when executed by the processor, cause the processor to perform actions including:
receiving, from a user equipment (UE), periodic measurement data associated with received signals from one or more cells visible to the UE;
determining that the processor of the access point has a capacity to process the periodic measurement data;
processing the periodic measurement data to generate a result; and
performing, based at least in part on the result, an action on the UE to optimize performance of the wireless communication network.
